(19) United States
(12) Patent Application Publication
(10) Pub. No.: US 2002/0084025 A1
(43) Pub. Date: Jul. 4, 2002

(54) Process and device for the production of cardboard cutouts

(76) Inventors: Juan Frederico Fisch, Monheim (DE); Wolfgang Heiber, Erkrath (DE); Julius Schroder Frerkes, Erkrath (DE)

Correspondence Address: Kevin W. Guynn, SONNENSCHEIN NATH & ROSENTHAL, Wacker Drive Station, Sears Tower, P.O. Box #061080, Chicago, IL, 60606-1080, US

(21) Appl. No.: 10/004,267

(22) Filed: Oct. 30, 2001

(30) Foreign Application Priority Data
Oct. 30, 2000 (DE) P 100 53 793.6

(51) Int. Cl. B32B 31/00

(52) U.S. Cl. 156/264; 156/278

(57) ABSTRACT

In a process and a device for the production of cardboard cutouts with glued-on second-material pieces, preferably film pieces for use as folding boxes with film window, in which the cardboard cutouts are glued at a gluing station by means of block cylinders, in order thereupon to obtain the film pieces applied by a suction cylinder, in which the transport of the cardboard cutouts occurs by suction bands, with avoidance of a contamination of the suction bands, a high precision for the applying of the film pieces onto the cardboard cutouts is ensured by the feature that the suction band or the section bands are supported in the zone of the block cylinder in such manner that partial zones defined according to construction of the supporting device of one or several suction bands are moved against the block cylinder or removed from the contact zone of the block cylinder. Especially suitably also in the case of multi-track moving of the cardboard cutouts only one suction band is provided, which is moved lowerably and raisably in partial zones.

### BACKGROUND OF THE INVENTION

The invention relates to a process and to a device for the production of cardboard cutouts with glued-on second-material pieces, preferably film pieces, for use as folding cartons with a film window, in which the carton cutouts are glued at a gluing station by means of a block cylinder, in order for the film pieces thereupon to be applied by a suction cylinder, the transport of the cardboard cutouts occurring by suction bands or belts.

In the field of window gluing-in for folding cartons, corresponding machines have long been known. The basic principle of these machines lies in that cardboard cutouts from a storage container are isolated, then aligned in a conveyor belt station in running direction and in transverse direction, then glued in a glueing station by means of a block cylinder, in order then to be fed to a suction cylinder which applies the film piece to the glued cardboard cutout. The transport of the cardboard cutouts from the gluing mechanism to the suction cylinder occurs, there, preferably by means of suction bands or belts, depending on machine width and construction type, between 1 and 12 suction bands.

In the event that a cutout is missed, all the known machines have an arrangement which either lowers the suction bands present under the gluing cylinder or raises the entire gluing cylinder, so that a contamination of the suction bands is avoided.

Contamination of the suction bands can occur through the blocks by means of which the glue application to the cardboard cutouts is performed. The blocks consist of flexible rubber or plastic. This flexibility is necessary in order to ensure a good glue application over the entire gluing pattern, since the cardboard cutout, the block, and the surface supporting the cardboard cutout are all in practice not completely level. The pressure of the block cylinder on the cardboard cutout is adjusted so that an optimal gluing pattern results. If a cardboard cut out thickness of about 0.4 mm is missed, then the gluing block contacts the suction band transporting the cardboard cutouts and delivers the glue to it. This glue contamination leads to the result that the glue deposits, after a circuit of the suction band, are given off to the underside of one of the following cardboard cutouts, and this cardboard cutout thereby becomes a reject article. The lowering of the suction band only in the track in which the cardboard cutout is absent is necessary so that the other tracks in which the cutouts that are present parallel to the missed cutout undergo a proper gluing.

The presence of several suction bands has the disadvantage that cutouts that are wider than one suction band are necessarily transported by more than one suction band. Since in practice the suction bands always have a slightly different speed, through different tensions, through different friction values of the surfaces supporting the suction bands, etc., this leads to minimal twistings of the cardboard cutouts during the transport from the conveyor belt station that aligns the cardboard cutouts, up to the suction cylinder applying the window. This effect is always troublesome when by reason of the formation of the carton a high precision is demanded for the applying of the window. For this reason the transport with only one suction band is always the best alternative. The use of only one suction band, however, hampers the multi-track production procedure, since up to the time point of the invention there was no system which permitted the partial lowering within a single suction band.

From DE-A-31 29 496 there is known a process for the continuous production of folding boxes, in which a window opening zone is glued over with a film piece of flexible plastic material. The film is drawn off from the supply roller, cut into pieces and (allegedly) glued in exact fit over the pre-stamped window opening zones.

From EP-0-391 927 B1 there is known a process for the production of film cutouts for folding boxes with angle windows, in which film cutouts from a transparent plastic are glued into folding boxes provided with a cutout. The material for the film cutouts is unwound there continuously from a roller and the film cutouts for the production of folding boxes are glued with the folding box cutouts.

With the aforementioned devices, however, especially in a multi-track procedure, a precise alignment of the fold box cutouts is not possible.

### SUMMARY OF THE INVENTION

Underlying the invention is the problem of showing a process and a device by means of which the above-mentioned disadvantages can be avoided and, especially, with the avoidance of a contamination of the suction bands, a high precision can be guaranteed for the placing of the film windows on the box cutouts, with simultaneously a high production rate by a one-track or several track procedure, and with the aim of drastically reducing the costs for the production of the folding boxes and the maintenance of the production installation. For the solution the invention proposes, in a process for the production of cardboard cutouts with glued on second material pieces, preferably film pieces for use as folding boxes with a film window, in which the cardboard cutouts are glued at a gluing station by means of block cylinders, in order to thereupon to receive the film pieces applied by a suction cylinder, the transport of the cardboard cutouts occurring by suction bands wherein the suction band or suction bands in the zone of the block cylinder are supported in such manner that the partial zones of one or several suction bands, defined according to the design of the supporting arrangement, are moved against the block cylinder or removed from the zone of contact with the block cylinder. In the event of a missing (absence of a) cardboard cutout, especially in multi-track operations, the corresponding suction bands are advantageously lowered in a partial zone of a track and, according to the invention, in this manner with maintenance of a relatively high production rate, a contamination of the following cardboard cutouts is avoided.

According to one form of execution of the invention it is provided that in a multitrack, parallel operating manner for cardboard cutouts, preferably only two to four suction bands are used in parallel and driven lowerably and raisably in partial zones. In an especially preferred variant of the invention, with multi-track and parallel operation of the cardboard cutouts, only one suction band is provided which in partial zones is driven lowerably and raisably both in lengthwise and also in transverse direction.

### BRIEF DESCRIPTION OF THE DRAWINGS

Further details, features and advantages of the invention are yielded from the following explanation of an example of execution schematically shown in the drawing. In the drawings:

FIG. 1 shows a schematic view of the device according to the invention for the production of cardboard cutouts with glued-on film pieces.

FIG. 2 is a schematic plan view of a multi-track installation according to FIG. 1.

FIG. 3 is a schematic plan view of a multi-track installation according to FIG. 1.

FIG. 4 is a schematic front view of a block cylinder with inventive supporting device arranged under it as pressure segments as well as flexible perforated plates in waiting position.

FIG. 5 is a schematic front view of a block cylinder with inventive supporting device arranged under it as pressure segment as well as flexible perforated plates in partly lowered position.

### DETAILED DESCRIPTION OF THE PREFERRED EMBODIMENTS

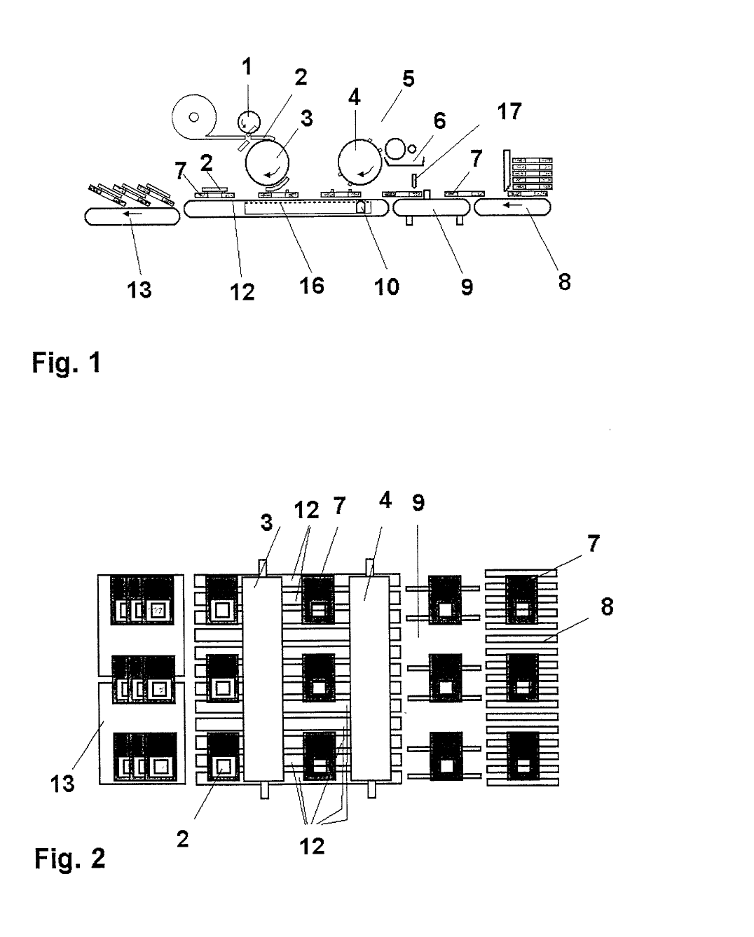

From FIGS. 1 and 2 there is to be seen the process scheme for the production of cardboard cutouts 7 with glued-on second-material pieces, preferably film pieces 2, for use as folding boxes with a film window.

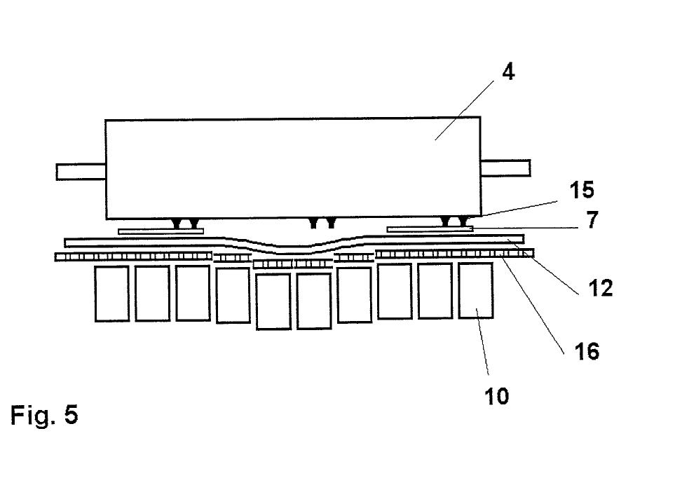

The cardboard cutouts 7 are drawn off from a storage container 8 and conveyed over a conveyor belt station 9 to the suction bands or belts 12 and there glued from above in the influence zone of the supporting device/pressure segment 10, at the gluing station 5, by means of a block cylinder 4. The block cylinder 4 and its gluing block (15, FIGS. 4 and 5) are supplied with glue from the glue tank 6. From a film roller simultaneously a film web is subdivided at a cutoff device 1 into film pieces 2, which are taken up from a suction cylinder 3 and deposited with exact fit on a glued cardboard cutout 7, after which the two, joined together, are conveyed onward by means of a lead-off band 13 to a stacking device (not represented) or directly further processed, i.e., set upright and filled.

Above the conveyor belt station 9 serving for aligning the cardboard cutouts 7 there is present per track a sensor, which may be in the form of a light barrier 17, which rhythmically checks the presence of a cardboard cutout 7. If a cardboard cutout 7 is missing, the light barrier 17 generates an impulse which leads to the lowering of the pressure segment 10 present in the zone of the concerned track. As soon as the light barrier 17 again detects a cardboard cutout 7 in the concerned track, the pressure segments 10 are again lifted and ensure a dependable application of glue.

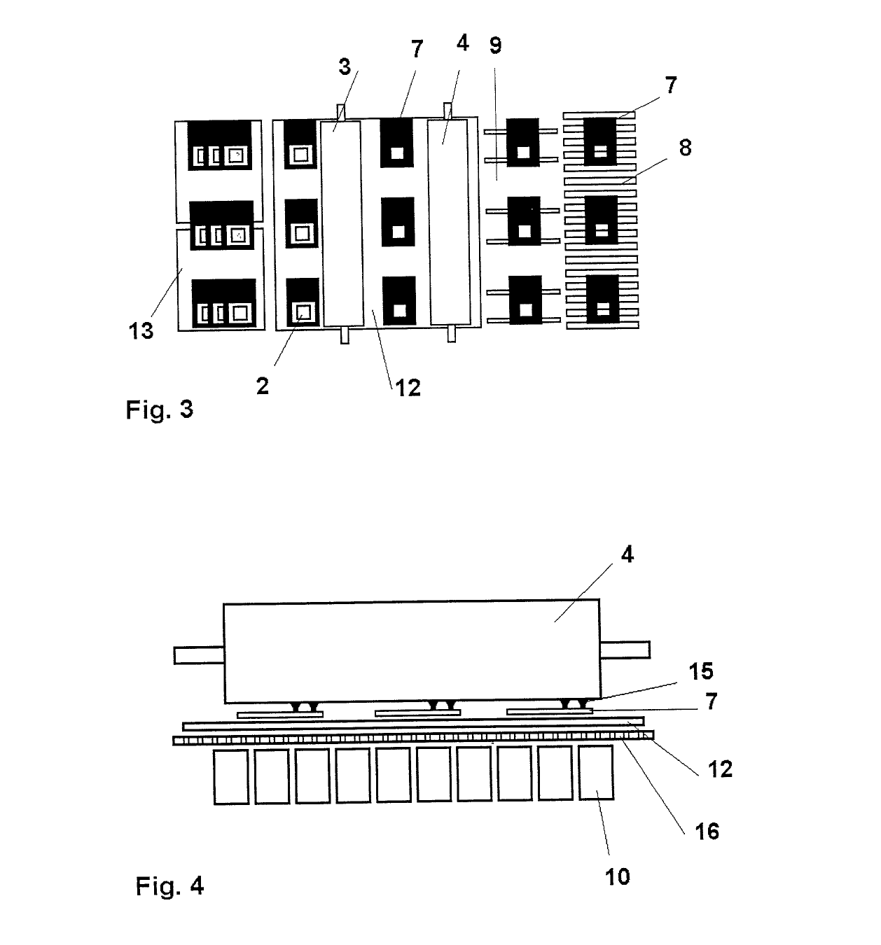

In FIG. 3, in distinction from FIG. 2, a window gluing machine is schematically represented in plan with only one suction band 12.

From the context of FIGS. 4 and 5, the operation according to the inventive process is clearly recognizable. According to this, the suction band 12 in the zone of the block cylinder 4 is supported in such manner that, depending on the design of the supporting device 10, defined partial areas of one and/or of several suction bands 12 are moved toward the block cylinder 4 or out of the contact zone of the block cylinder 4, in which process expediently above the pressure segments of the supporting device 10 and underneath the suction bands 12 flexible perforated plates 16 are arranged in the width of the particular pressure segments.

The measures and embodiments according to the invention are not restricted to the examples of execution represented in the drawing figures. Possible modifications of the inventive device can lie in that, for example, the supporting device or the pressure segments have different cross-section forms and/or different-type component groups are combined. The particular constructive from of execution is left to the specialist in adaptation to special uses.

As is apparent from the foregoing specification, the invention is susceptible of being embodied with various alterations and modifications which may differ particularly from those that have been described in the preceding specification and description. It should be understood that we wish to embody within the scope of the patent warranted hereon all such modifications as reasonably and properly come within the scope of our contribution to the art.

We claim as our invention:

1. A process for the production of cardboard cutouts with glued-on second-material pieces, in which the cardboard cutouts are glued at a gluing station by means of block cylinders, in order thereupon to receive the second material pieces applied by a suction cylinder, the transport of the cardboard cutouts occurring by at least one suction band, wherein the at least one suction band is supported in a zone of the block cylinder via a supporting device in such manner that defined partial areas of the at least one suction band are moved toward the block cylinder or moved away from the zone of the block cylinder.

2. A process according to claim 1, wherein the second material pieces comprise film pieces.

3. A process according to claim 2, wherein the cardboard cutouts and film pieces are formed into folding boxes with film windows.

4. A process according to claim 1, wherein, with multi-track parallel operation of the cardboard cutouts, two to four suction bands are used in parallel and are driven lowerably or raisably in the partial areas.

5. A process according to claim 1, wherein, with multi-track, parallel operation of the cardboard cutouts, only one suction band is provided, which in the partial areas is driven lowerably and raisably both in longitudinal and also in transverse direction.

6. A process according to claim 1, wherein the support of the supporting device in the partial areas occurs under sensor control, by means of at least one light barrier.

7. A device for the production of cardboard cutouts with glued-on second-material pieces, comprising a gluing station in the form of a rotatable glue cylinder, at least one suction band which carries the cardboard cutouts below the glue cylinder, and a plurality of vertically movable pressure segments positioned below the suction band in a zone below the glue cylinder.

8. A device according to claim 7, wherein above the pressure segments of the supporting device and beneath the suction belt, there are arranged flexible perforated plates in the width of the individual pressure segments.

9. A device according to claim 7, wherein above the pressure segments of the supporting device and beneath the suction belt, rollers are arranged in the width of the particular pressure segments.

10. A device according to claim 7, wherein above the conveyor belt there is provided at least one a light sensor, which checks the presence of a cardboard cutout.

11. A device according to claim 7, wherein said at least one suction band carries the cardboard cutouts in a plurality of parallel tracks.

12. A device according to claim 11, wherein two to four suction bands are arranged in parallel for carrying the cardboard cutouts below the glue cylinder and are constructed raisable and lowerable in partial areas.

13. A device according to claim 11, wherein only one suction belt is provided for carrying the cardboard cutouts below the glue cylinder and is constructed lowerable and raisable in partial areas in longitudinal and also in transverse direction.

14. A process for the production of cardboard cutouts with glued-on second-material pieces, comprising the steps of
applying glue to the cardboard cutouts at a gluing station by means of at least one glue cylinder rotating about an axis,
transporting the cardboard cutouts via suction conveyor belts moving transverse to the cylinder axis,
supporting the suction conveyor belt in a contact zone underlying the glue cylinder axis via a plurality of independently vertically movable support segments such that defined partial areas of the suction conveyor belt are raised toward the glue cylinder zone or lowered away from the glue cylinder contact zone via the support segments.

15. A process according to claim 14, wherein the second material comprises film pieces for forming a window in the cardboard cutouts.

16. A process according to claim 14, including the step of transporting the cardboard cutouts in multiple parallel tracks utilizing a plurality of suction conveyor belts arranged in a parallel manner, each of the conveyor belts being raised or lowered in partial areas below the contact zone of the glue cylinder.

17. A process according to claim 16, wherein two to four suction belts are used.

18. A process according to claim 14, including the step of transporting the cardboard cutouts in multiple parallel tracks utilizing a single suction belt which is raised or lowered in partial areas below the contact zone of the glue cylinder both in longitudinal and also in transverse direction.

19. A process according to claim 14, including the step of utilizing a sensor control to control movement of the support segments.

20. A process according to claim 19, wherein the sensor control includes light barriers.
